(19) United States
(12) Patent Application Publication
(10) Pub. No.: US 2007/0058826 A1
(43) Pub. Date: Mar. 15, 2007

(54) Condenser microphone

(75) Inventors: Norihiro Sawamoto, Shizuoka (JP); Hiroshi Fujinami, Shizuoka (JP); Yasunori Tsukuda, Shizuoka (JP); Motoaki Ito, Shizuoka (JP); Kentaro Yonehara, Shizuoka (JP)

Correspondence Address: SUGHRUE-265550, 2100 PENNSYLVANIA AVE. NW, WASHINGTON, DC, 20037-3213, US

(73) Assignee: STAR MICRONICS CO., LTD.

(21) Appl. No.: 11/519,977

(22) Filed: Sep. 13, 2006

(30) Foreign Application Priority Data
Sep. 13, 2005 (JP) P2005-264887

(51) Int. Cl. H04R 25/00

(52) U.S. Cl. 381/174

(57) ABSTRACT

A microphone element having a diaphragm and a fixed electrode disposed opposite to each other on a silicon board having a central opening portion is mounted and fixed onto a base board having a sound hole. A perimeter-shaped side board and a cover board are mounted and fixed onto the board, thereby forming a back cavity on an upper side of the microphone element. The diaphragm and the fixed electrode are conducted to conductive layers of the cover board through conductive layers of the base board, and a conductive layer and a coiled spring in the side board respectively, and mounting on a surface of a printed board of an external apparatus can be carried out in a conductive layer on an upper surface thereof.

### BACKGROUND OF THE INVENTION

1. Field of the Invention

The present invention relates to a condenser microphone and more particularly to a condenser microphone having a microphone element configured by using a silicon board.

2. Description of the Related Art

In general, a condenser microphone has such a structure as to have a condenser constituting portion in which a diaphragm and a fixed electrode are disposed opposite to each other. In recent years, there has also been a devisal for manufacturing the condenser constituting portion as a microphone element by utilizing a so-called MEMS (Micro Electro Mechanical Systems) technique in order to reduce a size.

For example, JP-A-2005-183437 discloses a condenser microphone including a microphone element in which a diaphragm and a fixed electrode are disposed opposite to each other over a silicon board having a central opening portion formed therein. In the condenser microphone, the microphone element is mounted and fixed onto a base board and a case for covering the microphone element from above is fixed to an outer peripheral edge portion of the base board, and a sound hole for guiding a sound to the microphone element is formed on an upper surface portion of the case. The condenser microphone is mounted on a surface of a printed board of an external apparatus via the base board.

### SUMMARY OF THE INVENTION

In the condenser microphone disclosed in JP-A-2005-183437, a back cavity taking a shape of a trapezoidal pyramid is formed between the microphone element and the base board. In order to maintain a predetermined acoustic characteristic of the condenser microphone, it is necessary to set the back cavity to have a certain volume or more. For this purpose, it is necessary to increase a size of a silicon board to a large extent.

In such a case, a size of the microphone element is also increased. For this reason, there is a problem in that the condenser microphone cannot be configured to be compact.

In consideration of the circumstances, it is an object of the invention to provide a condenser microphone having a microphone element configured by using a silicon board, in which a predetermined acoustic characteristic can be maintained, and furthermore, which can be configured to be compact.

The invention achieves the object by devising a structure for accommodating a microphone element.

More specifically, a condenser microphone according to the invention comprises a microphone element having a diaphragm and a fixed electrode disposed opposite to each other on a silicon board having a central opening portion, a base board for mounting and fixing the microphone element thereto, a perimeter-shaped side board mounted and fixed onto the base board to surround the microphone element, and a cover board mounted and fixed onto the side board to cover the microphone element from above, wherein a sound hole for guiding a sound to the microphone element is formed in a lower position of the central opening portion of the silicon board in the base board, and a plurality of first conductive layers for carrying out a conduction to each of the diaphragm and the fixed electrode are formed to be extended to a position of a lower surface of the side board in a plurality of portions on an upper surface of the base board, a second conductive layer for carrying out a conduction to the first conductive layer is formed in an opposed position to the first conductive layer on a lower surface of the cover board, and a third conductive layer to be conducted to the second conductive layer is formed on an upper surface of the cover board, and a conductive path for conducting the first conductive layer to the second conductive layer is formed in the side board.

As long as the “microphone element” has the diaphragm and the fixed electrode disposed opposite to each other over the silicon board having the central opening portion, a specific structure thereof is not particularly limited.

As long as the “conductive path” can conduct each of the first conductive layers to each of the second conductive layers, a specific conducting structure thereof is not particularly limited.

The specific conducting structure of each of the “second conductive layers” and each of the “third conductive layers” is not particularly limited.

As in the structure, the condenser microphone according to the invention has such a structure as to comprise a microphone element having a diaphragm and a fixed electrode disposed opposite to each other on a silicon board having a central opening portion, a base board for mounting and fixing the microphone element thereto, a perimeter-shaped side board mounted and fixed onto the base board to surround the microphone element, and a cover board mounted and fixed onto the side board to cover the microphone element from above. The sound hole for guiding a sound to the microphone element is formed in a lower position of the central opening portion of the silicon board in the base board, and a plurality of first conductive layers for carrying out a conduction to each of the diaphragm and the fixed electrode are formed to be extended to a position of a lower surface of the side board in a plurality of portions on an upper surface of the base board, a second conductive layer for carrying out a conduction to the first conductive layer is formed in an opposed position to the first conductive layer on a lower surface of the cover board, a third conductive layer to be conducted to the second conductive layer is formed on an upper surface of the cover board, and a conductive path for conducting the first conductive layer to the second conductive layer is formed on the side board. Therefore, it is possible to obtain the following functions and advantages.

That is, the base board is provided with the sound hole in the lower position of the central opening portion of the silicon board. Therefore, it is possible to utilize, as a back cavity, a space surrounded by the base board, the side board and the cover board on the upper side of the microphone element. In that case, the back cavity can easily be set to have a greater volume as compared with the case in which the space taking a shape of a trapezoidal pyramid which is formed between the microphone element and the base board is utilized for the back cavity as in the conventional art.

Therefore, it is possible to obtain a back cavity having a necessary volume for maintaining a predetermined acoustic characteristic even if a size of the silicon board is not increased differently from the conventional art. Consequently, it is possible to constitute the condenser microphone to be compact by reducing a size of the microphone element.

Moreover, both the diaphragm and the fixed electrode are conducted to the third conductive layer through the first conductive layer, the conductive path and the second conductive layer. If the condenser microphone is vertically inverted and is mounted on a surface of the printed board of an external apparatus with the third conductive layer directed downward, therefore, it is possible to dispose the condenser microphone with the sound hole directed upward in the same manner as in the conventional condenser microphone.

According to the invention, thus, it is possible to maintain a predetermined acoustic characteristic in the condenser microphone having the microphone element formed by using the silicon board, and furthermore, to constitute the condenser microphone to be compact.

In the structure, the specific structure of each of the conductive paths is not particularly restricted as described above. By forming the through hole on the side board and inserting and disposing the conductive member on the through hole to constitute the conductive path, however, it is possible to easily conduct each of the first conductive layers to each of the second conductive layers.

The specific structure of the “conductive member” is not particularly restricted but it is possible to employ a spring member such as a coiled spring or a plated through hole constituted by forming a conductive layer on an inner peripheral surface of the through hole. In this case, by employing the coiled spring, it is possible to reliably conduct the first conductive layer and the second conductive layer with a simple structure. In that case, by using the coiled spring and the plated through hole together, it is possible to conduct them more reliably. In addition, by employing the plated through hole, it is possible to obtain a smooth surface. Therefore, the coiled spring can be inserted and disposed easily.

In the structure in which the fourth conductive layers to be conducted to the first conductive layers formed on the upper surface of the base board are provided on the lower surface thereof, it is possible to carry out mounting on the surface of the printed board of an external apparatus with the fourth conductive layer directed downward even if the condenser microphone is not inverted vertically. At this time, the condenser microphone is mounted on the surface with the sound hole turned downward. In the case in which an opening portion corresponding to the sound hole is formed on the printed board of the external apparatus, however, such an embodiment can also be employed. With such a structure that a plurality of fourth conductive layers are formed on the lower surface of the base board, it is possible to use the condenser microphone also in a state in which the sound hole is directed in any of upper and lower directions.

In this case, the specific conductive structure of each of the “first conductive layers” and each of the “fourth conductive layers” is not particularly limited.

### BRIEF DESCRIPTION OF THE DRAWINGS

FIG. 1 is a sectional side view showing a state in which a condenser microphone according to an embodiment of the invention is directed upward, which is taken along a I-I line in FIG. 2;

FIG. 2 is a view showing a state in which a cover board of the condenser microphone is removed as seen in a II-II line of FIG. 1;

FIG. 3 is a sectional side view showing a state in which the condenser microphone is mounted on a surface of a printed board of an external apparatus;

FIG. 4 is a sectional side view showing a state in which a condenser microphone according to a modified embodiment is directed upward;

FIG. 5 is a sectional side view showing a state in which the condenser microphone is mounted on a surface of a printed board of an external apparatus; and

FIG. 6 is a sectional side view showing a conventional condenser microphone having a structure approximating to the condenser microphone according to the embodiment as greatly as possible in order to make a comparison with the condenser microphone according to the embodiment.

### DETAILED DESCRIPTION OF THE PREFFERED EMBODIMENTS

With reference to the drawings, an embodiment of the invention will be described below.

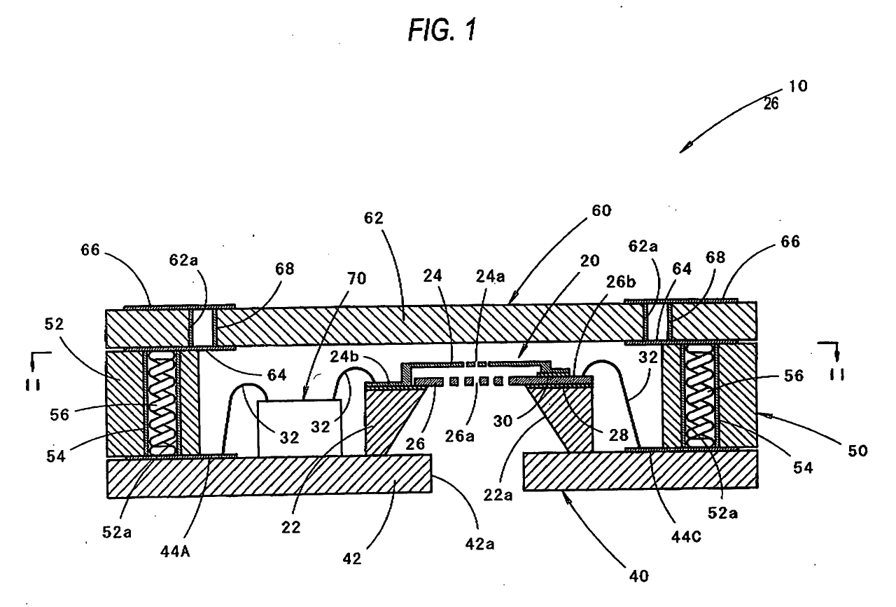

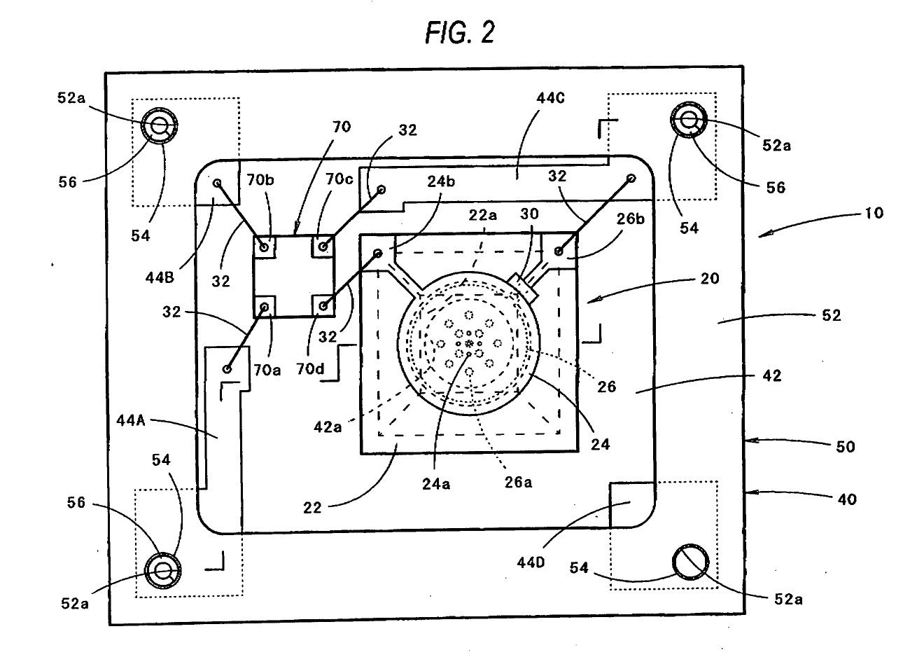

FIG. 1 is a sectional side view showing a state in which a condenser microphone 10 according to an embodiment of the invention is directed upward, and FIG. 2 is a view seen in a II-II line in FIG. 1. FIG. 1 is a sectional view taken along a I-I line in FIG. 2.

As shown in these drawings, the condenser microphone 10 according to the embodiment comprises a microphone element 20, a base board 40, a side board 50, a cover board 60 and an IC chip 70.

The microphone element 20 has such a structure that a diaphragm 24 and a fixed electrode 26 are disposed opposite to each other on a silicon board 22 having a central opening portion 22a formed therein, and is manufactured by using an MEMS technique.

The silicon board 22 is configured by single crystal silicon cut out to have a size of approximately 1 mm square from a silicon wafer and has a thickness of approximately 0.3 mm. The central opening portion 22a of the silicon board 22 is formed to take a shape of a trapezoidal pyramid by an etching treatment such as alkali etching. An insulating layer 28 formed by a silicon oxide film is formed around the central opening portion 22a on an upper surface of the silicon board 22.

The fixed electrode 26 is formed by polycrystalline silicon and is formed to close the central opening portion 22a on an upper surface of the insulating layer 28. The fixed electrode 26 is formed to have a greater size than that of the central opening portion 22a and a plurality of through holes 26a are formed to face the central opening portion 22a in a central part thereof. Moreover, a terminal portion 26b extended toward a corner portion of the silicon board 22 is formed in an outer peripheral edge portion of the fixed electrode 26.

The diaphragm 24 is formed by polycrystalline silicon and is formed to be extended in parallel with the fixed electrode 26 in the vicinity of an upper part of the fixed electrode 26. The diaphragm 24 is formed to be a size larger than the fixed electrode 26, and is laminated on the insulating layer 28 in an outer peripheral edge portion thereof. An insulating layer 30 is provided between repetitive laminated portions of the diaphragm 24 and the terminal portion 26b of the fixed electrode 26. A condenser constituting portion is formed by the diaphragm 24 and the fixed electrode 26. A plurality of very small through holes 24a are formed for ventilation in a central part of the diaphragm 24. Moreover, a terminal portion 24b extended toward another corner portion of the silicon board 22 is formed in the outer peripheral edge portion of the diaphragm 24.

The base board 40 is configured by an insulating board 42 taking an external shape of a rectangle which is close to a square having a side of approximately 3 to 4 mm as seen on a plane and conductive layers 44A, 44B, 44C and 44D formed in four corner portions on the upper surface of the insulating board 42 respectively. The microphone element 20 is mounted and fixed in an almost central position of the insulating board 42. The mounting and fixation is carried out by bonding and fixing a lower surface of the silicon board 22 of the microphone element 20 to an upper surface of the base board 40. Moreover, a sound hole 42a for guiding a sound to the microphone element 20 is formed in a lower position of the central opening portion 22a of the silicon board 22 in the base board 40.

The IC chip 70 takes, as an electric signal, a change in an electrostatic capacity between the diaphragm 24 and the fixed electrode 26 which is caused by a vibration of the diaphragm 24, and furthermore, amplifies the electric signal. The IC chip 70 is bonded and fixed to the upper surface of the base board 40 adjacently to the microphone element 20.

The side board 50 is mounted and fixed onto the base board 40 in order to surround the microphone element 20 and the IC chip 70.

The side board 50 is configured by an insulating board 52 formed to take a shape of a rectangular ring (perimeter shape) and provided with a through hole 52a extended in a vertical direction in each corner portion, and a conductive layer 54 formed on an inner peripheral surface of each through hole 52a of the insulating board 52.

The insulating board 52 takes the same external shape as a shape of the base board 40 as seen on a plane and is formed to have almost the same width over a whole periphery. A thickness of the insulating board 52 is set to have a slightly greater value than a height of the IC chip 70. Each through hole 52a has an inner peripheral surface provided with the conductive layer 54 and is thus configured as a plated through hole.

Each of the conductive layers 44A, 44B, 44C and 44D formed on the upper surface of the base board 40 is formed to be extended from a lower position of each through hole 52a of the side board 50 to a position exposed to a space portion on an inner peripheral side of the side board 50. The side board 50 is mounted and fixed onto the base board 40 by bonding using a conductive adhesive.

A coiled spring 56 having a slightly greater free length than the through hole 52a is inserted and disposed in three of the four through holes 52a of the side board 50 which are positioned above the conductive layers 44A, 44B and 44C. The residual conductive layer 44D is a dummy conductive layer formed to be adapted to the height of the other conductive layers 44A, 44B and 44C in the three places and thus the through hole 52a positioned thereon is not equipped with a coiled spring 56.

The IC chip 70 includes a power terminal 70a, an output terminal 70b, a ground terminal 70c and a bias terminal 70d. The power terminal 70a, the output terminal 70b, the ground terminal 70c and the bias terminal 70d are electrically connected to the conductive layer 44A, the conductive layer 44B, the conductive layer 44C, and the terminal portion 24a of the diaphragm 24 through a bonding wire 32, respectively. Moreover, the terminal portion 26b of the fixed electrode 26 is electrically connected to the conductive layer 44C through the bonding wire 32.

The cover board 60 is configured by an insulating board 62 having the same external shape as the base board 40 as seen on a plane, a conductive layer 64 formed in each corner portion on the lower surface of the insulating board 62, a conductive layer 66 formed in each corner portion on the upper surface of the insulating board 62, and a conductive layer 68 for conducting each conductive layer 64 and each conductive layer 66 in each corner portion of the insulating board 62. A through hole 62a is formed in a portion in the vicinity of the upper part of each through hole 52a in each corner portion of the insulating board 62, and the conductive layer 68 is formed on an inner peripheral surface of each through hole 62a.

The conductive layers 64, 66 and 68 corresponding to the conductive layer 44D are dummy conductive layers formed to be adapted to the heights of the conductive layers 64, 66 and 68 in the three other portions.

The cover board 60 is mounted and fixed onto the side board 50 in order to cover the microphone element 20 from above. The mounting and fixation is carried out by bonding using a conductive adhesive. Moreover, each coiled spring 56 is deformed slightly elastically in a direction of a compression in the mounting and fixation and both upper and lower ends thereof are caused to reliably abut on the conductive layers 44A, 44B and 44C of the base board 40 and each conductive layer 64 of the cover board 60 corresponding thereto in order to surely carry out the conduction.

In the condenser microphone 10 according to the embodiment, a closed space to be a back cavity is formed on an upper side of the microphone element 20 by the base board 40, the side board 50 and the cover board 60.

The silicon board 22 and the insulating board 42 are bonded to each other by applying an adhesive without a clearance over a whole lower surface of the silicon board 22 in order to completely isolate the back cavity from a front cavity. Consequently, a sound of the front cavity can be prevented from entering the back cavity from a lower surface side of the silicon board 22, which otherwise causes a deterioration in a sensitivity of the condenser microphone 10.

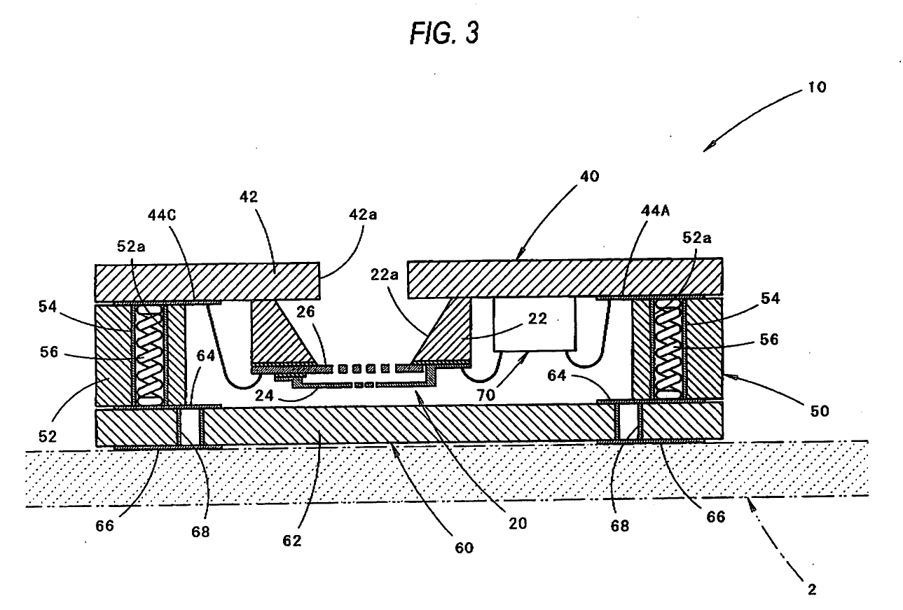

As shown in FIG. 3, the condenser microphone 10 according to the embodiment is used in a state in which it is mounted on the surface of a printed board 2 of an external apparatus (for example, a cellular phone).

The surface mounting is carried out by causing each conductive layer 66 to abut on a conductive layer pattern of the printed board 2 and performing soldering in a state in which the condenser microphone 10 is inverted vertically and is disposed with the sound hole 42a directed upward.

As described above in detail, the condenser microphone 10 according to the embodiment has such a structure as to comprise the microphone element 20 having the diaphragm 24 and the fixed electrode 26 disposed opposite to each other on the silicon board 22 having the central opening portion 22a formed therein, the base board 40 for mounting and fixing the microphone element 20 thereto, the perimeter-shaped side board 50 mounted and fixed onto the base board 40 to surround the microphone element 20, and the cover board 60 mounted and fixed onto the side board 50 to cover the microphone element 20 from above. The sound hole 42a for guiding a sound to the microphone element 20 is formed in the lower position of the central opening portion 22a of the silicon board 22 in the baseboard 40, and the conductive layers 44A, 44B and 44C to be the first conductive layers for carrying out a conduction to each of the diaphragm 24 and the fixed electrode 26 are formed to be extended to the position of the lower surface of the side board 50 in a plurality of portions on the upper surface of the baseboard 40, the conductive layers 64 to be the second conductive layers for carrying out a conduction to the conductive layers 44A, 44B and 44C are formed in the opposed positions to the conductive layers 44A, 44B and 44c on the lower surface of the cover board 60, and furthermore, the conductive layer 66 to be the third conductive layer which is to be conducted to the conductive layer 64 is formed on the upper surface of the cover board 60, and the conductive path for conducting each of the conductive layers 44A, 44B and 44C to each of the conductive layers 64 is formed on the side board 50 through the conductive layer 54 and the coiled spring 56. Therefore, it is possible to obtain the following functions and advantages.

That is, the insulating board 42 of the base board 40 is provided with the sound hole 42a in the lower position of the central opening portion 22a of the silicon board 22. Therefore, it is possible to utilize, as a back cavity, the space surrounded by the base board 40, the side board 50 and the cover board 60 on the upper side of the microphone element 20. The back cavity can easily be set to have a greater volume as compared with the case in which a space taking a shape of a trapezoidal pyramid which is formed between the microphone element and the base board is utilized for the back cavity as in the conventional art.

This aspect will be described below in detail.

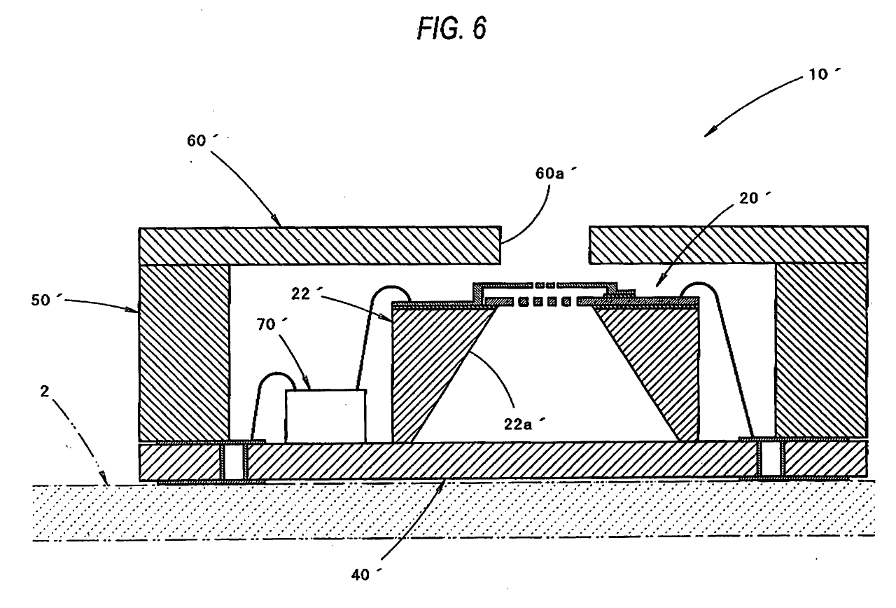

FIG. 6 is a sectional side view showing a conventional condenser microphone 10′ to have a structure approximating to the condenser microphone 10 as greatly as possible in order to carry out a comparison with the condenser microphone 10 according to the embodiment.

In the condenser microphone 10′ shown in FIG. 6, a perimeter-shaped side board 50′ is mounted and fixed onto a base board 40′ for mounting and fixing a microphone element 20′ and an IC chip 70′ in order to surround the microphone element 20′ and the IC chip 70′, and furthermore, a cover board 60′ is mounted and fixed onto the side board 50′ in order to cover the microphone element 20′ and the IC chip 70′ from above. In the condenser microphone 10′, a sound hole 60a′ is formed on the cover board 60′. The condenser microphone 10′ is mounted on a surface of a printed board 2 of an external apparatus in the base board 40′. Consequently, the condenser microphone 10′ is used in a state in which the sound hole 60a′ is directed upward. In the condenser microphone 10′, a closed space taking a shape of a trapezoidal pyramid, which is formed between the microphone element 20′ and the base board 40′, is formed as a back cavity.

In the condenser microphone 10′, it is necessary to greatly increase a size of a silicon board 22′ of the microphone element 20′ as shown in FIG. 6 in order to maintain a back cavity having a necessary volume for obtaining a predetermined acoustic characteristic. In that case, a central opening portion 22a′ of the silicon board 22′ has a trapezoidal pyramid-shaped slant face provided at an inclination angle along a crystal orientation of single crystal silicon. Therefore, it is necessary to increase the size of the silicon board 22′ in both horizontal and vertical directions. For this reason, the size of the microphone element 20′ is also increased three-dimensionally. Consequently, the condenser microphone 10′ cannot be made compact.

On the other hand, in the condenser microphone 10 according to the embodiment, the sound hole 42a is formed in the lower position of the central opening portion 22a of the silicon board 22 in the base board 40. Therefore, the closed space surrounded by the base board 40, the side board 50 and the cover board 60 on the upper side of the microphone element 20 can be utilized as the back cavity. Thus, it is possible to obtain a back cavity having a necessary volume for maintaining a predetermined acoustic characteristic without increasing the size of the silicon board 22 as in the case of the condenser microphone 10′ shown in FIG. 6. Consequently, the size of the microphone element 20 is reduced so that the condenser microphone 10 can be configured to be compact.

In the condenser microphone 10 according to the embodiment, moreover, the conductive layers 44A, 44B and 44C formed on the upper surface of the base board 40 are conducted to the conductive layers 64 formed on the lower surface of the cover board 60 through the conductive path formed on the side board 50, and each of the conductive layers 64 is conducted to each of the conductive layers 66 formed on the upper surface of the cover board 60. By vertically inverting the condenser microphone 10 and downward mounting each of the conductive layers 66 on the surface of the printed board 2 of an external apparatus, therefore, it is possible to use the condenser microphone 10 with the sound hole 42a directed upward in the same manner as in the condenser microphone 10′ shown in FIG. 6.

According to the embodiment, thus, the condenser microphone 10 having the microphone element 20 configured by using the silicon board 22 can be formed to be compact while maintaining a predetermined acoustic characteristic.

In addition, in the embodiment, each of the conductive paths formed on the side board 50 has such a structure that the through hole 52a is formed in the insulating board 52 of the side board 50, and furthermore, the conductive layer 54 is formed in the through hole 52a to constitute the plated through hole and the coiled spring 56 is inserted and disposed in the plated through hole. Therefore, each of the conductive layers 44A, 44B and 44C and each of the conductive layers 64 can be conducted easily and reliably. Moreover, each through hole 52a is set to be the plated through hole so that a smooth surface can be obtained. Thus, it is possible to easily insert and dispose the coiled spring 56.

Next, description will be given to a modified embodiment.

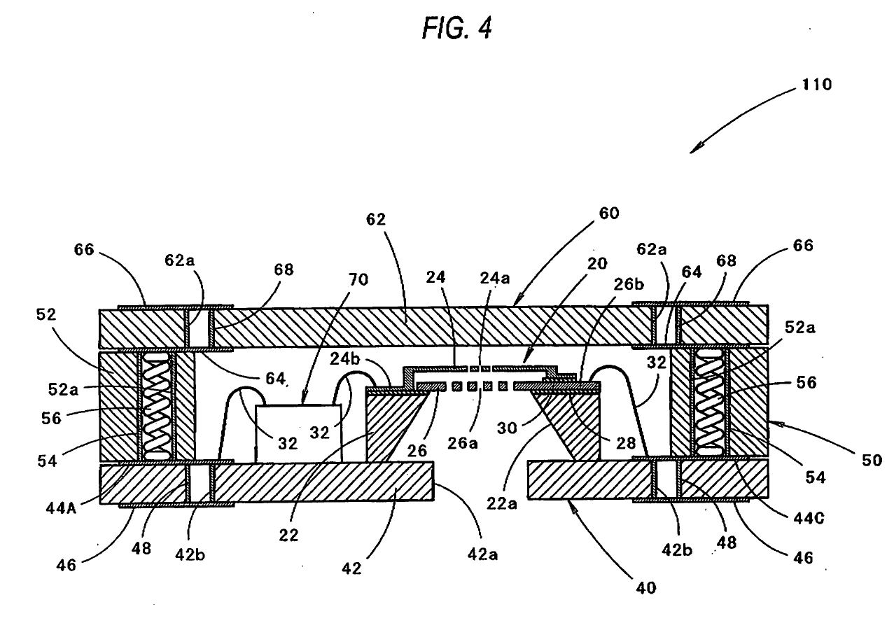

FIG. 4 is a sectional side view showing a state in which a condenser microphone 110 according to the modified embodiment is directed upward.

As shown in FIG. 4, the condenser microphone 110 according to this modified embodiment has a basic structure which is the same as that of the condenser microphone 10 according to the above embodiment, but a structure of a base board 40 is partially different from that in the embodiment.

More specifically, in the condenser microphone 110 according to the modified embodiment, a conductive layer 46 to be conducted to each of conductive layers 44A, 44B, 44C and 44D formed on an upper surface of an insulating board 42 in the base board 40 is formed as a fourth conductive layer on a lower surface of the insulating board 42. A through hole 42b is formed in a portion provided in the vicinity of a lower part of each through hole 52a in each of corner portions of the insulating board 42, and a conductive layer 48 for conducting each of the conductive layers 44A, 44B, 44C and 44D to each conductive layer 46 is formed on an inner peripheral surface of each of the through holes 42b.

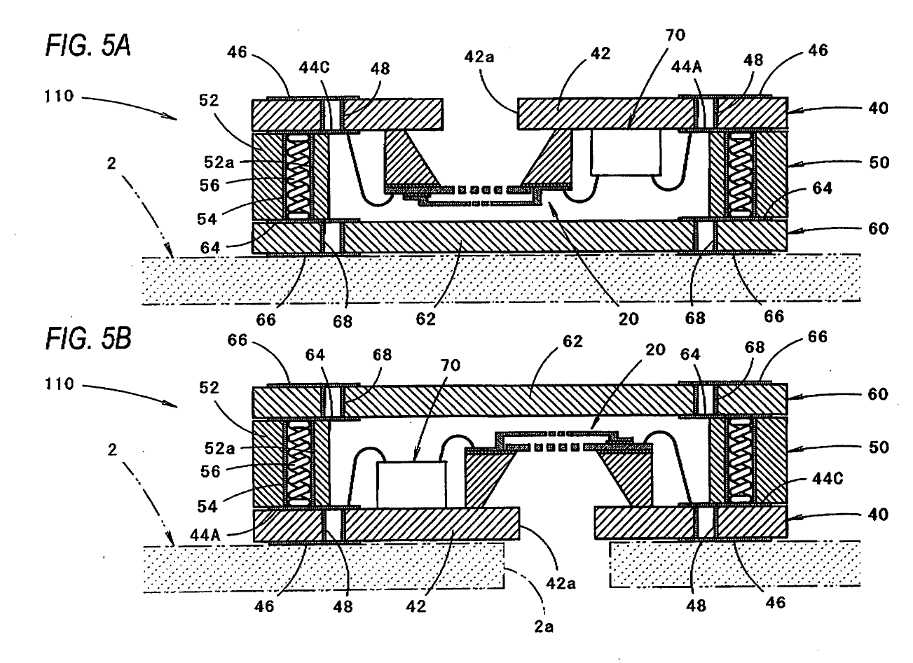

By employing the structure of the condenser microphone 110 according to this modified embodiment, the condenser microphone 110 can be vertically inverted and mounted on a surface of a printed board 2 of an external apparatus in the same manner as the condenser microphone 10 according to the above embodiment as shown in FIG. 5A, and furthermore, the condenser microphone 110 can be mounted on the surface of the printed board 2 in the conductive layer 46 without being vertically inverted, as shown in FIG. 5B. At this time, the condenser microphone 110 is mounted on the surface with a sound hole 42a directed downward. In the case in which an opening portion 2a corresponding to the sound hole 42a is formed on the printed board 2, such an embodiment can also be employed. By causing the base board 40 to have the structure in which a plurality of conducive layers 46 are formed on the lower surface of the insulating board 42, thus, it is possible to use the condenser microphone 110 also in a state in which the sound hole 42a is directed in any of upper and lower directions.

While the description has been given on the assumption that the condenser microphones 10 and 110 take the rectangular external shapes which are close to a square in the embodiment and the modified embodiment, it is a matter of course that the other external shapes can betaken. Moreover, it is also possible to properly set the numeric values indicated as data in the embodiment and the modified embodiment to be different values.

While the description has been given on the assumption that the IC chip 70 is bonded and fixed to the upper surface of the base board 40 adjacently to the microphone element 20 in the condenser microphones 10 and 10 according to the embodiment and the modified embodiment, the IC chip 70 may be provided in the other arrangements. Furthermore, it is also possible to have a structure in which the IC chip 70 is not constituted as a part of the condenser microphones 10 and 110 but is separately mounted on the printed board 2 of the external apparatus.

What is claimed is:

1. A condenser microphone comprising:
a microphone element having a diaphragm and a fixed electrode disposed opposite to each other on a silicon board having a central opening portion;
a base board for mounting and fixing the microphone element thereto;
a perimeter-shaped side board mounted and fixed onto the base board to surround the microphone element; and
a cover board mounted and fixed onto the side board to cover the microphone element from above,
wherein a sound hole for guiding a sound to the microphone element is formed in a lower position of the central opening portion of the silicon board in the base board,
a plurality of first conductive layers for carrying out a conduction to each of the diaphragm and the fixed electrode are formed to be extended to a position of a lower surface of the side board in a plurality of portions on an upper surface of the base board,
a second conductive layer for carrying out a conduction to the first conductive layer is formed in an opposed position to the first conductive layer on a lower surface of the cover board,
a third conductive layer to be conducted to the second conductive layer is formed on an upper surface of the cover board, and
a conductive path for conducting the first conductive layer to the second conductive layer is formed in the side board.

2. The condenser microphone according to claim 1, wherein the conductive path is configured by forming a through hole in the side board and inserting a conductive member in the through hole.

3. The condenser microphone according to claim 2, wherein a coiled spring is used as the conductive member.

4. The condenser microphone according to claim 1, wherein a fourth conductive layer to be conducted to the first conductive layer is formed on a lower surface of the base board.

5. The condenser microphone according to claim 2, wherein a fourth conductive layer to be conducted to the first conductive layer is formed on a lower surface of the base board.

6. The condenser microphone according to claim 3, wherein a fourth conductive layer to be conducted to the first conductive layer is formed on a lower surface of the base board.

7. The condenser microphone according to claim 1, wherein the second conductive layer comprises a plurality of second conductive layers that are conducted to the plurality of first conductive layers, respectively.

8. The condenser microphone according to claim 7, wherein the third conductive layer comprises a plurality of third conductive layers that are conducted to the plurality of second conductive layers, respectively.

9. The condenser microphone according to claim 1, wherein the fourth conductive layer comprises a plurality of fourth conductive layers that are conducted to the plurality of first conductive layers, respectively.

10. The condenser microphone according to claim 7, wherein the conductive path comprises a plurality of conductive paths for conducting the plurality of first conductive layers to the plurality of second conductive layers, respectively.
